(19) United States
(12) Patent Application Publication
(10) Pub. No.: US 2003/0005093 A1
(43) Pub. Date: Jan. 2, 2003

(54) Server configuration versioning tool

(75) Inventors: Timothy G. Deboer, Toronto (CA); Timothy M. Francis, Keswick (CA); Sheldon B. Wosnick, Richmond Hill (CA); Siu Chung Yuen, Scarborough (CA)

Correspondence Address: IBM CORPORATION, T.J. WATSON RESEARCH CENTER, P.O. BOX 218, YORKTOWN HEIGHTS, NY, 10598, US

(73) Assignee: IBM

(21) Appl. No.: 10/064,011

(22) Filed: Jun. 4, 2002

(30) Foreign Application Priority Data
Jun. 4, 2001 (CA) 2,349,654

(51) Int. Cl. G06F 15/16; G06F 15/177

(52) U.S. Cl. 709/220; 709/203

(57) ABSTRACT

Embodiments of the invention enable the association of server configuration data with an application or project. Additionally, embodiments of the invention may enable multiple versions of server configuration data (which in some embodiments are versioned separately from the associated application or project) to be stored. Advantageously embodiments of the invention enable a server to be configured in accordance with versioned configuration data (often stored in one or more configuration files) such that the server performs in a well understood manner. This advantageous feature enables, amongst others, a developer to more quickly identify the source of any problems which may have been introduced as a result of modifications made to the application being tested.

### BACKGROUND OF INVENTION

1. Field of the Invention

The present invention relates to configuration of servers and, more particularly, to a server configuration versioning tool.

Background of the Invention

Computer servers are widely used in many computer installations. A computer server, forming part of a network of computer servers (hereinafter “servers”) and computer clients (hereinafter “clients”), will receive requests for data, provide a wide variety of data processing services and transmit data to clients and other servers.

Servers, operating or being deployed on a computer system, provide a multitude of functions and services to other servers and other computer clients. A computer system may operate to act as a single server or may enable a number of servers to operate, independently.

Some well known types of servers include, for example, print servers (which provide printing services to other servers and/or clients), web servers (which provide web page services to connected computers), file servers (which provide file access and file storage services), application servers (which may provide business logic or application delivery services), database servers (which provide for the storage of databases and/or database management services) as well as many others.

Generically, a server will enable another computer (whether another server or a client) to process (e.g., running or execution, storage, handling, etc.) user code. User code can be any type of data such as executable code, applications, files, databases and the like.

As will be understood by those of ordinary skill in the art, there numerous type of environments in which a server may be deployed. Examples of different operating environment variables which may affect the operation of a server include: whether a server may be one of many servers operating on a single computer system; the location in the network of a server; the location of files on the computer system or the network; the operating system being employed on the computer system in which the server is deployed; the user code the server is to process; as well as many parameters and variables. In order to reflect the variety of environments in which a server may be deployed, a server is typically configured in order to operate properly on the computer system on which the server will be deployed (i.e., located and executed).

As is known to those skilled in the art, the proper operation of an application which is to processed or executed by a server depends on the configuration of the processing server. That is, an application may be designed to operate on a particular server (e.g., a Tomcat or WebSphere® web server) provided that particular server is properly configured. A server, otherwise capable of processing or executing an application, may, when improperly configured, fail to properly process the application.

In the present development environment, applications are developed in the development environment where the application is coded and then tested (with these steps being repeated as necessary) until an application is deemed to be ready for deployment in a customer or operating setting. Also during the development phase the application, a developer typically will “version” the application using version control software. That is, the developer will store the various components (e.g., source code files, object code, EJBs, JSPs, etc.) in a repository (e.g., a database) which allows for the application (or a portion thereof) at a specified point in time to be saved. The version control software provides for the automated management solution for controlling, maintaining and tracking software development. Versioning control software (also known as source control management—SCM) typically enables files to be “checked out” and “checked in”. Thus, when an application is being developed by a team of developers, the versioning control software will allow different versions of the application to be saved and retrieved. SCM software, in some instances, will also allow multiple changes to be made concurrently by different developers, and then merged correctly. Other features of versioning control software are known to those skilled in the art.

As an application progresses through the development process, an application developer may test the application-under-development on a server configured by the developer or another member of the team to which the developer belongs.

As a result of this present application development environment, application developers are focused on the various artifacts (e.g., Enterprise Java Beans—EJBs, servlets, JavaServer Pages—JSPs, HTML files, etc.) that form the application and are not, generally, concerned with the server side operation and configuration.

After (many) modifications due to developer based testing, an application may be transferred to a person or team dedicated to testing or licensed to a customer. The deployment setting then involves the configuration and operation of the server for the developed application.

A recipient of the developed application (whether a test person/team or a customer) will then deploy the application on a server configured by the recipient. As can be expected, differences in server configuration between the developer's server and the recipient's server can result in bugs or other operational difficulties being identified.

As such, there is presently no known method to ensure that an application which has been deployed on a server will execute in the server environment (i.e., the server configuration) with which the application is known to operate as desired.

Additionally, as many applications are now typically developed in a team environment, a single developer may, after modifying some code, test the code by processing it on a team's server. However, if the server has be reconfigured (by, for example, another member of the development team), the modified code may not operate as expected. The developer may waste enormous amounts of time in identifying the problem which may be a result of the reconfiguration of the team server.

In a further shortcoming of the present application development and deployment environment is the difficulty experienced by application testing teams and application customers in identifying bugs or other causes for any operational difficulties experienced as a result of executing or processing the application. As indicated above, operational difficulties may be the result of coding errors (or bugs) or the configuration of the server upon which the application is operating. Accordingly, identifying the exact source of any problem can be time consuming.

Accordingly, a server configuration versioning tool which addresses, at least in part, some of these shortcomings is desired.

### SUMMARY OF INVENTION

The present invention is directed to a server configuration versioning tool which addresses, at least in part, the various described shortcomings.

Embodiments of the invention enable a developer to associate a server configuration with an application or project. Additionally, embodiments of the invention may enable multiple versions of a server configuration (which in some embodiments are versioned separately from the associated application or project) to be stored.

Advantageously embodiments of the invention enable a developer to configure a server in accordance with versioned configuration data (often stored in one or more configuration files) which is known to have configured a server such that the server performs in a well understood manner. This advantageous feature enables a developer to more quickly identify the source of any problems which may have been introduced as a result of modifications made to the application being tested.

In a further advantage, an application can be transferred to another party (e.g., another developer, a test team, a customer, etc.) with associated server configuration data. As such, a developer can be reasonably assured of the configuration of server on which the application is to be executed or processed.

In a further advantage of the present invention, a developer, having been informed, by another party of operational problems of the application, can be assured that the other party's server is configured in a particular manner.

In a further advantage of the present invention, two parties (e.g., a developer and a tester, a developer and a customer, etc.) are more quickly able to ascertain the cause of operational problems due to their ability to more quickly and accurately reproduce the execution environment in which the application is operating.

Other advantages of embodiments of the present invention will be apparent to those of ordinary skill in the art.

In accordance with an aspect of the present invention there is provided a method for executing an application on a server, said method comprising: transferring to said server a package, said server for execution on a computer platform, said package comprising said application and server configuration data, said server configuration data comprising data to configure said server for said application; configuring said server with said server configuration data; and executing said server and said application. In accordance with another aspect of the present invention there is provided a method of preparing an application said method comprising: packaging files composing said application with server configuration data, said server configuration data comprising one or more server configuration files, each of said one or more server configuration files adapted to configure a server to execute said application. In accordance with still another aspect of the present invention there is provided A versioning tool for performing a method of preparing an application said method comprising: packaging files composing said application with server configuration data, said server configuration data comprising one or more server configuration files, each of said one or more server configuration files adapted to configure a server to execute said application.

In accordance with still another aspect of the present invention there is provided a method of versioning server configuration files, said method comprising: within a package comprising an application associating a version of a server configuration file with said application, said version of a server configuration file adapted to configure a server to process said application.

In accordance with still another aspect of the present invention there is provided a computer readable medium storing data and instructions, said data and instructions adapting a computer system to: transfer to said server a package, said server for execution on a computer platform, said package comprising said application and server configuration data, said server configuration data comprising data to configure said server for said application; configure said server with said server configuration data; and execute said server and said application. Other aspects and features of the present invention will become apparent to those ordinarily skilled in the art upon review of the following description of specific embodiments of the invention in conjunction with the accompanying figures.

### BRIEF DESCRIPTION OF DRAWINGS

The figures illustrate an example embodiment for this invention.

FIG. 1 schematically illustrates a computer system embodying aspects of the invention.

FIG. 2 schematically illustrates, in greater detail, a portion of the computer system of FIG. 1.

FIG. 3 illustrates, in functional block form, a portion of FIG. 2.

FIG. 4 is a flowchart of exemplary operations of the computer system of FIG. 1.

### DETAILED DESCRIPTION

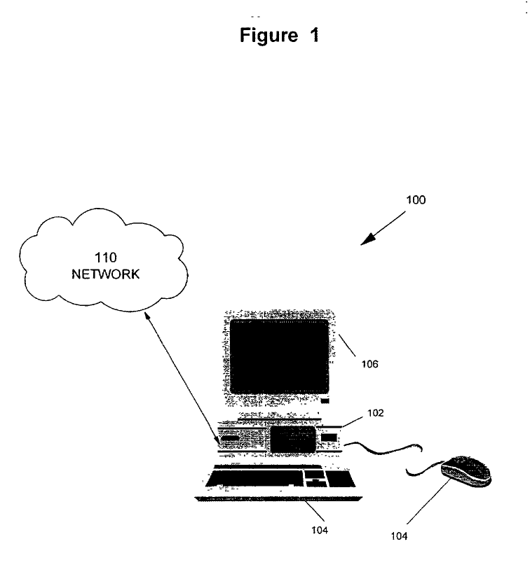

An embodiment of the invention, computer system 100, is illustrated in FIG. 1. Computer system 100, illustrated for exemplary purposes as a networked computing device, is in communication with other networked computing devices (not shown) via network 110. As will be appreciated by those of ordinary skill in the art, network 110 may be embodied using conventional networking technologies and may include one or more of the following: local area networks, wide area networks, intranets, public Internet and the like. As is discussed with reference to FIG. 8, computer system 100 may interact with other networked computer systems (not shown) providing application analysis of a distributed application.

Throughout the description herein, an embodiment of the invention is illustrated with aspects of the invention embodied solely on computer system 100. As will be appreciated by those of ordinary skill in the art, aspects of the invention may be distributed amongst one or more networked computing devices which interact with computer system 100 via one or more data networks such as, for example, network 110. However, for ease of understanding, aspects of the invention have been embodied in a single computing device—computer system 100.

Computer system 100 includes processing system 102 which communicates with various input devices 104, output devices 106 and network 110. Input devices 104, two of which are shown, may include, for example, a keyboard, a mouse, a scanner, an imaging system (e.g., a camera, etc.) or the like. Similarly, output devices 106 (only one of which is illustrated) may include displays, information display unit printers and the like. Additionally, combination input/output (I/O) devices may also be in communication with processing system 102. Examples of conventional I/O devices include removable and fixed recordable media (e.g., floppy disk drives, tape drives, CD-ROM drives, DVD-RW drives, etc.), touch screen displays and the like.

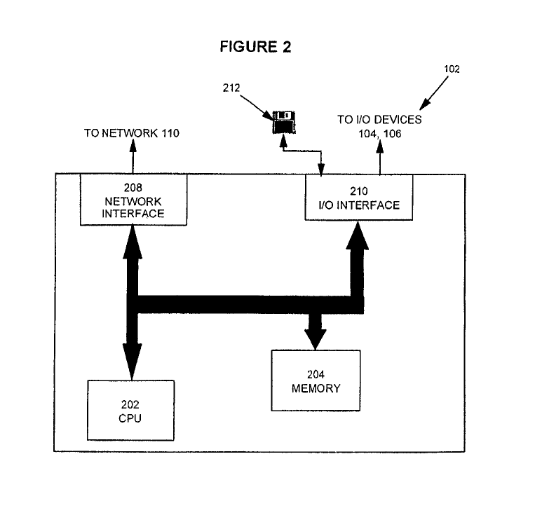

Exemplary processing system 102 is illustrated in greater detail in FIG. 2. As illustrated, processing system 102 includes several components—central processing unit (CPU) 202, memory 204, network interface (I/F) 208 and I/O I/F 210. Each component is in communication with the other components via a suitable communications bus 206 as required.

CPU 202 is a processing unit, such as an Intel Pentium™, IBM PowerPC™, Sun Microsystems UltraSparc™ processor or the like, suitable for the operations described herein. As will be appreciated by those of ordinary skill in the art, other embodiments of processing system 102 could use alternative CPUs and may include embodiments in which one or more CPUs are employed. CPU 202 may include various support circuits to enable communication between itself and the other components of processing system 102.

Memory 204 includes both volatile and persistent memory for the storage of:

operational instructions for execution by CPU 202, data registers, application storage and the like. Memory 204 preferably includes a combination of random access memory (RAM), read only memory (ROM) and persistent memory such as that provided by a hard disk drive.

Network I/F 208 enables communication between computer system 100 and other network computing devices (not shown) via network 110. Network I/F 208 may be embodied in one or more conventional communication devices. Examples of a conventional communication device include an Ethernet card, a token ring card, a modem or the like. Network I/F 208 may also enable the retrieval or transmission of instructions for execution by CPU 202 from or to a remote storage media or device via network 110.

I/O I/F 210 enables communication between processing system 102 and the various I/O devices 104, 106. I/O I/F 210 may include, for example, a video card for interfacing with an external display such as output device 106. Additionally, I/O I/F 210 may enable communication between processing system 102 and a removable media 212. Although removable media 212 is illustrated as a conventional diskette other removable memory devices such as Zip™ drives, flash cards, CD-ROMs, static memory devices and the like may also be employed. Removable media 212 may be used to provide instructions for execution by CPU 202 or as a removable data storage device.

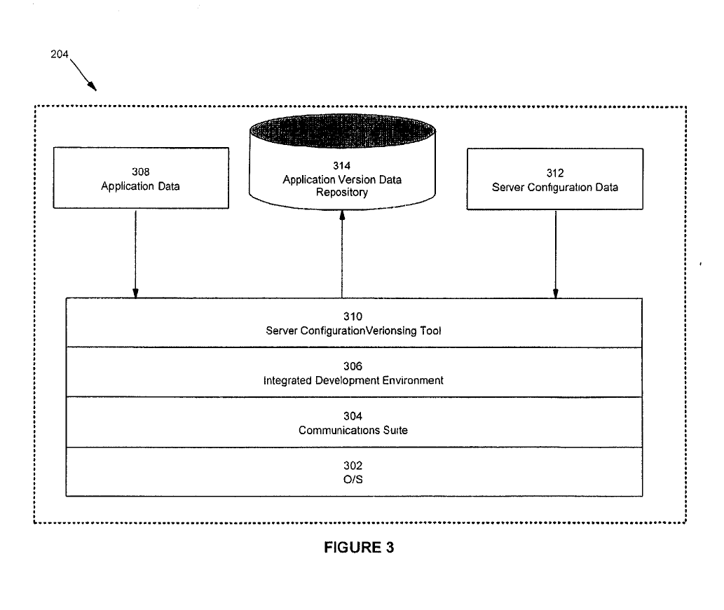

The computer instructions/applications stored in memory 204 and executed by CPU 202 (thus adapting the operation of computer system 100 as described herein) are illustrated in functional block form in FIG. 3. As will be appreciated by those of ordinary skill in the art, the delineation between aspects of the applications illustrated as functional blocks in FIG. 3 is somewhat arbitrary as the various operations attributed to a particular application as described herein may, in alternative embodiments, be subsumed by another application.

As illustrated, for exemplary purposes only, memory 202 stores operating system (OS) 302, communications suite 304, development application 306, application behavior event and data logger 308, database 310 (storing data corresponding to the behavior of development application 306 and object model 314) and two application analysis tools 312A and 312B.

OS 302 is an operating system suitable for operation with a selected CPU 202 and the operations described herein. Multitasking, multithreaded OSes such as, for example, IBM AIX™, Microsoft Windows NT™, Linux or the like, are expected in many embodiments to be preferred.

Communication suite 304 provides, through, interaction with OS 302 and network I/F 208 (FIG. 2), suitable communication protocols to enable communication with other networked computing devices via network 110 (FIG. 1). Communication suite 304 may include one or more of such protocols such as TCP/IP, ethernet, token ring and the like.

Integrated development environment (IDE) 306 enables the development of an application for eventual deployment on a server. The application can include many different components including (but not limited to), for example, servlets, EJBs, JSPs, HTML files, applets, source code, object code and the like. An exemplary IDE is TM provide by the IBM™ product, VisualAge™ for Java™ which enables a developers to create many of the exemplary components identified above. Competing and similar products are available from other companies such as Borland Inc., Microsoft Corp. and the like.

IDE 306 may also enable the creation of a project. A project may comprise one or more components. Additionally, IDE 306 may include debugging features, testing clients and many other tools needed by developers in the present day development environment.

IDE 306 may also include a file versioning tool which could be adapted to perform the functions described herein. For example, the IBM VisualAge product includes a feature identified as External Version Control which provides file versioning features.

However, in the exemplary embodiment, IDE 306 is separate from the server configuration versioning tool (SCVT) 310 which is described in greater detail below. As will be appreciated by those of ordinary skill in the art upon reading the entire description, separation IDE 306 and SCVT 310 enables a user of an embodiment of the present invention to use an IDE 306 of their choosing and combine the selected IDE 306 with an SCVT 310 also of the user's choosing.

SCVT 310 provides a mechanism for associating one more server configuration files with a project, component, file or application or the like (hereinafter referred to collectively as an “application”) under development. It will be appreciated that the term “server configuration file” includes any format for server configuration data. Many servers are presently configured using one or more text files. However, a “server configuration file”, as used herein, is not limited to this structure but, rather, refers, to any data which is used to configure a server for operation with a particular application, project or the like. Additionally, data for configuring a single server may, in fact, reside in several files. However, in the present description and for ease of understanding, all data, whether stored in a single or multiple files, for configuring a single server is referred to herein as a “server configuration file”.

In addition to the foregoing functions, SCVT 310 provides for the versioning of each server configuration file associated with an application. The versioning of server configuration files, much like versioning of source code, provides an indicia (typically a timestamp or text) associated with a version of a selected server configuration file so that a user can place a particular version of server configuration file into context. For example, a first version of server configuration file may be associated with an indicia, such as the timestamp (e.g., May 1, 2001). A second version of the same server configuration file may be associated with a second timestamp (e.g., Jun. 1, 2001). Accordingly, a developer testing changes to an application which previously operated properly using the May 1, 2001 version of the server configuration file may choose to configure a server using that version rather than risk the possibility that the Jun. 1, 2001 version of the server configuration file would induce some operational problems in the recently modified version of the application.

Additionally, SCVT 310 provides server configuration files associated with different server environments to be associated with a particular application. For example, an application may be developed which is designed to operate with a plurality of web servers (e.g., Tomcat and WebSphere). Accordingly, different server configurations are likely required in this exemplary instance. SCVT 310 provides a developer to store versions of server configuration files which are specific to the server (or other environment parameter). Accordingly and as explained in greater detail below, a developer, through the advantages provided by SCVT 310, can transfer an application with an associated configuration file to a recipient (e.g., a tester, a customer, another computer system, etc.)—the associated configuration file designed to ensure proper operation of the application on the server operated by the recipient.

In the exemplary embodiment described herein, SCVT 310 is embodied by conventional version control software adapted to perform the functions and operations described herein However, and as will be appreciated by those of ordinary skill in the art from the description contained herein, SCVT 310 could be embodied as a separate tool performing functions and operations described herein which do not form part of conventional version control software.

Application data 308 is data associated with the application under development. In many instances application data 308 will include source code, libraries and the like, known to those skilled in the art.

Server configuration file 312 comprises data (often in the form of one or more files) for configuring a server. As will be understood, a server configuration file 312 is often specific to the server, the environment in which the server is to operate (e.g., computer system related parameters) and the application which is to be processed by the server. Server configuration file 312 may be modified or created through use of, for example, a standard editor. Other tools (e.g., configuration wizards, etc.) for the editing or modification of server configuration file 312 may also be employed. As alluded to above, a change in an application may require modification of an associated server configuration file 312. Accordingly, it is to be expected that a server configuration file 312 associated with a particular application which is undergoing development is likely to require modification as development progresses.

Version data repository 314 stores both application data 308 and server configuration data 312. Additionally, version data repository 314 also stores metadata relating to application data 308 and server configuration data 312. Repository 314 may be embodied, for example, in a conventional relational database or a proprietary data storage format.

The metadata may include (but is not limited to), for example, data describing a particular file or component (e.g., text data), version data (e.g., a version number or version text descriptor), timestamp data, indicator data indicating whether a piece of data (e.g., a file) has been checked out (and if so, by whom) and the like. In the exemplary embodiment, the metadata also includes association data which associates application data 308 with one or more server configuration files which form part of server configuration data 312. This association data may be in the form of, for example, a relation or linking between a one or more server configuration files and corresponding application data.

The linkage or association between an application and a single instance of a server configuration file is, in the exemplary embodiment, maintained within the server configuration file itself. That is, part of the configuration of a server is the list of applications that are installed on that server, and that list can be used within the development environment to make the linkage clear to the user and to the server which is configured by the server configuration file. In the exemplary embodiment, the association between the different versions of an application and the different versions of a server configuration file is typically managed by SCVT 310. For example, version 1.3 of the application may be associated with version 1.0 of a server configuration file, while version 2.0 of an application may be associated with version 2.7 of the server configuration file.

In an alternative embodiment, the linkage or association between an application and one or more server configuration files could be embedded within the application itself.

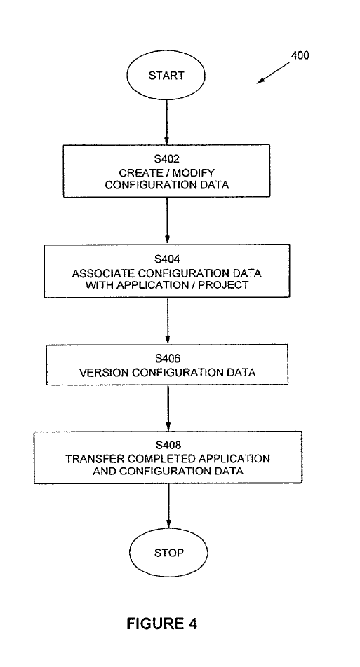

The operation of computer system 100 (FIG. 1) and, more particularly, the operation and interaction of IDE 306, SCVT 310, application data 308 with server configuration data 312 is better understood with reference to operations 400, performed by these various components of computer system 100, which is illustrated in flowchart form in FIG. 4.

Initially, in operations 400, a user will provide to computer system 100, and more particularly SCVT 310, a server configuration file which has been newly created or recently modified (S402). The server configuration file may have been created using known tools (e.g., an editor or the like) or checked out or otherwise previously retrieved from application data repository 314. SCVT 310 may be provided with server configuration file in different manners. For example, if SCVT 310 provides a command line interface, a server configuration file may be provided by file name (or other indicia) in conjunction with an executable representing SCVT 310. Alternatively, if SCVT 310 provides a graphical user interface (which is common in many environments), SCVT 310 may be provided with a file name (or other indicia) through various inputs (e.g., keystrokes, mouse clicks, voice control, etc.). In a future alternative, SCVT 310 may be provided with the server configuration file by providing a suitable application programming interface. In this latter alternative, SCVT 310 may be called by another program (rather than by a user).

The received server configuration file, which forms server configuration data 312, is stored in data repository 314. Additionally, SCVT 310 receives additional data associated with the server configuration file received in S402. This additional configuration data received forms part of the metadata described above. This may include textual description data (e.g., “Configuration File for Tomcat Server”, “Prepared by Tim Francis”, etc.), timestamp data, version identifying data (e.g., “WebSphere Configuration File, Version 1.6”, etc.), or the like.

In addition to the foregoing metadata, SCVT 310 receives application association data (S404). Application association data associates a particular server configuration file (or a version thereof) with a particular application (or version thereof). As will be appreciated, a particular server configuration file (or version thereof) may be associated with one or more applications (or versions thereof and/or one or versions of an application. Similarly, a particular application (or version thereof) may be associated with one or more server configurations (or versions thereof). Additionally, neither an application (or version thereof) or server configuration file (or version thereof) need be associated with the other. That is, for example, a server configuration file could be stored in repository 314. However, additional benefits are achieved by SCVT 310 when association data is received.

The association data, once received by SCVT 310, is also stored in repository 314.

The examples described above suggest explicit association data being received by SCVT 310. However, in an alternative embodiment, the association data may be implicit. For example, in an IDE, a developer may include a server configuration file as part of a project. In this instance, the association data received by SCVT 310 results from the storage and packaging of the entire project including the server configuration file. The association between the application which forms part of the project and a server configuration file, which also form part of the same project, results in this implicit association.

In a further operation, S406, SCVT 310 receives data to select one or more server configuration files (stored within repository 314) and the particular versions thereof. This data is then used during the building or compiling of an application which is to be transferred. As a result of operation S406 an application and one or more versions of server configuration files are bundled to form a single package. For example, an application may be associated with configuration files for two different servers (e.g., a WebSphere web server and a Tomcat web server). Each web server may be deployed on several different platforms (a platform being a combination of the underlying physical hardware and the operating system executing thereon). Accordingly, a package for an application may select the latest version of server configuration files for each web server for all supported platforms. In an exemplary situation of six platforms being supported for both web servers, twelve different configuration files may be packaged with an application so that each possible combination can be easily supported. The package thus formed can then be stored on a medium for transfer (e.g., a network accessible drive, CD-ROMs, DVD-ROMs, etc.) The package formed in S406 can then be transferred to another party (e.g., a test team, a customer, another computer system, etc.)When a package is accessed (by a user, for example), a selection of one or more configuration files bundled therein may then be made. For example, a user having a specific platform (e.g., a Linux operating system on an IBM iSeries™ server) running IBM WebSphere web server, and attempting to install and execute an application which has been packaged (as described above) and transferred (by CD-ROM, Internet connection, etc.) to the user, may select one of the configuration files contained within the package. The selected configuration file will, having been designed to operate on the user specific platform and with the associated application contained within the package, in most instances operate as designed by the development team.

From the foregoing, persons of ordinary skill in the art will appreciate that embodiments of the present invention enable a developer to associate a server configuration with an application or project. Additionally, embodiments of the invention may enable multiple versions of a server configuration (which in some embodiments are versioned separately from the associated application or project) to be stored.

In a further advantage, embodiments of the invention enable a developer to configure a server in accordance with versioned configuration data (often stored in one or more configuration files) which is known to have configured a server such that the server performs in a well understood manner. This advantageous feature enables a developer to more quickly identify the source of any problems which may have been introduced as a result of modifications made to the application being tested.

In a further advantage, an application can be transferred to another party (e.g., another developer, a test team, a customer, etc.) with associated server configuration data. As such, a developer can be reasonably assured of the configuration of server on which the application is to be executed or processed.

In a further advantage of the present invention, a developer, having been informed, by another party of operational problems of the application, can be assured that the other party's server is configured in a particular manner.

In a further advantage of the present invention, two parties (e.g., a developer and a tester, a developer and a customer, etc.) are more quickly able to ascertain the cause of operational problems due to their ability to more quickly and accurately reproduce the execution environment in which the application is operating.

Other advantages of embodiments of the present invention will be apparent to those of ordinary skill in the art.

As will be appreciated by those skilled in the art, modifications to the above-described embodiment can be made without departing from the essence of the invention While one (or more) embodiment(s) of this invention has been illustrated in the accompanying drawings and described above, it will be evident to those skilled in the art that changes and modifications may be made therein without departing from the essence of this invention. All such modifications or variations are believed to be within the sphere and scope of the invention as defined by the claims appended hereto. Other modifications will be apparent to those skilled in the art and, therefore, the invention is defined in the claims.

1. A method for executing an application on a server, said method comprising:
transferring to said server a package, said server for execution on a computer platform, said package comprising said application and server configuration data, said server configuration data comprising data to configure said server for said application;
configuring said server with said server configuration data; and
executing said server and said application.

2. The method of claim 1
wherein said server configuration data comprises one or more server configuration files; and
wherein the configuring step further comprises the steps of:
selecting one of said one or more server configuration files; said selected one adapted to configure said server; and
configuring said server with said selected one of said one or more server configuration files.

3. The method of claim 2 further comprising the step of providing some of said one or more server configuration files with versions of one server configuration file.

4. The method of claim 3 further comprising the step of providing each of said versions of said one server configuration file with data associating said each of said versions with a version of said application.

5. The method of claim 3 further comprising the step of providing said application with data associating said application with at least one of said versions of said one or more server configuration files.

6. The method of claim 2 further comprising the step of providing at least one of said one or more server configuration files with a first server configuration file adapted to configure a first server and further comprising the step of providing another of said one or more server configuration files with a second server configuration file adapted to configure a second server.

7. The method of claim 2 further comprising the step of providing at least one of said one or more server configuration files with a first server configuration file adapted to configure a first server for execution on a first computer system platform and further comprising the step of providing another of said one or more server configuration files with a second server configuration file adapted to configure said first server for execution on a second computer system platform.

8. A method of preparing an application said method comprising the steps of:
packaging files composing said application with server configuration data, and providing said server configuration data with one or more server configuration files, each of said one or more server configuration files adapted to configure a server to execute said application.

9. The method of claim 8 wherein said configuring step further comprising the steps of providing:
selecting one of said one or more server configuration files; said selected one adapted to configure said server; and
configuring said server with said selected one of said one or more server configuration files.

10. The method of claim 9 further comprising the step of providing some of said one or more server configuration files with versions of one server configuration file.

11. The method of claim 10 further comprising the step of providing each of said versions of said one server configuration file with data associating said each of said versions with a version of said application.

12. The method of claim 10 further comprising the step of providing said application with data associating said application with at least one of said versions of said one or more server configuration files.

13. The method of claim 9 further comprising the step of providing at least one of said one or more server configuration files with a first server configuration file adapted to configure a first server and further comprising the step of providing another of said one or more server configuration files with a second server configuration file adapted to configure a second server.

14. The method of claim 9 further comprising the step of providing at least one of said one or more server configuration files with a first server configuration file adapted to configure a first server for execution on a first computer system platform and further comprising the step of providing another of said one or more server configuration files with a second server configuration file adapted to configure said first server for execution on a second computer system platform.

15. A versioning tool for preparing an application, said tool comprises:
packaging files composing said application with server configuration data, wherein said server configuration data is provided with one or more server configuration files, each of said one or more server configuration files adapted to configure a server to execute said application.

16. A method of versioning server configuration files, said method comprising the step of:
within a package comprising an application associating a version of a server configuration file with said application, said version of a server configuration file adapted to configure a server to process said application.

17. The method of claim 16 further comprising the step of providing said associating with embedding association data within said version of said server configuration file linking said version of said server configuration file with said application.

18. The method of claim 16 further comprising the step of providing said associating with embedding association data with said application linking said application with at least one of said plurality of versions of said server configuration file.

19. The method of claim 17 further comprising the step of providing said package further with said version of said server configuration file.

20. A computer readable medium storing data and instructions, said data and instructions adapting a computer system to:
transfer to said server a package, said server for execution on a computer platform, said package comprising said application and server configuration data, said server configuration data comprising data to configure said server for said application;
configure said server with said server configuration data; and
execute said server and said application.

21. The computer readable medium of claim 20 wherein said server configuration data comprises one or more server configuration files; and wherein said adaptation to configure comprises adapting said computer system to:
select one of said one or more server configuration files; said selected one adapted to configure said server; and
configure said server with said selected one of said one or more server configuration files.

22. The computer readable medium of claim 21 wherein some of said one or more server configuration files comprise versions of one server configuration file.

23. The computer readable medium of claim 22 wherein each of said versions of said one server configuration file comprises data associating said each of said versions with a version of said application.

24. The computer readable medium of claim 22 wherein said application comprises data associating said application with at least one of said versions of said one or more server configuration files.

25. The computer readable medium of claim 21 wherein at least one of said one or more server configuration files comprises a first server configuration file adapted to configure a first server and wherein another of said one or more server configuration files comprises a second server configuration file adapted to configure a second server.
